(19) United States
(12) Patent Application Publication
(10) Pub. No.: US 2015/0095469 A1
(43) Pub. Date: Apr. 2, 2015

(54) IDENTIFIER-BASED COMMUNICATION METHOD USING APPLICATION PROGRAM INTERFACE

(71) Applicant: ELECTRONICS AND TELECOMMUNICATIONS RESEARCH INSTITUTE, Daejeon (KR)

(72) Inventors: Jeong-Hwan KIM, Daejeon (KR); Woo-Jik CHUN, Seoul (KR)

(21) Appl. No.: 14/499,112

(22) Filed: Sep. 27, 2014

(30) Foreign Application Priority Data
Sep. 30, 2013 (KR) 10-2013-0116783
Aug. 12, 2014 (KR) 10-2014-0104490

(51) Int. Cl. H04L 12/24

(52) U.S. Cl. CPC H04L 41/0803
USPC 709/220

(57) ABSTRACT

An identifier (ID)-based communication method using an application program interface (API) is provided. The method, which is performed by an application, includes generating an ID plug interface, and binding an ID of the application to the generated ID plug interface; requesting a domain controller to do a domain search through the ID plug interface; receiving a domain socket interface list from the domain controller through the ID plug interface; selecting one domain socket interface in the domain socket interface list; and requesting a combination (plug-in) of the ID plug interface and the selected domain socket interface.

### CROSS-REFERENCE TO RELATED APPLICATION

This application claims priority to and the benefit of Korean Patent Application Nos. 10-2013-0116713 and 10-2014-0104490, filed on Sep. 30, 2013 and Aug. 12, 2014, respectively, the disclosures of which are incorporated herein by reference in their entirety.

### BACKGROUND

1. Field of the Invention

The present invention relates to identifier (ID)-based communication, and more particularly, to an application program interface (API) for the ID-based communication, and a communication method using the same.

2. Discussion of Related Art

An IP-based communication architecture is architecture proposed in order to solve various problems such as mobility and multi-homing, which occur since an IP address simultaneously performs functions of an ID and an address in current IP-based communication, and is architecture in which the ID and a locator are separated.

In conventional IP-based communication, applications perform data transmission and reception through a socket interface. The socket interface is subordinate to the IP address and characteristics of a network layer, and for this, application developers need to have knowledge about an IP and the network characteristics.

Meanwhile, in the ID-based communication architecture, it is possible for communication subject to communicate with a communication target only by designating an ID of a communication target regardless of the address and the network characteristics, etc, of the communication target in the ID-based communication architecture, since a conventional socket interface having a dependency on network technology cannot be used as it is, an API suitable for the ID-based communication is needed.

### SUMMARY OF THE INVENTION

The present invention is directed to an ID-based communication interface needed for communication of an application program in an ID-based communication architecture and a communication method using the ID-based communication interface.

According to an aspect of the present invention, there is provided an identifier (ID)-based communication method using an application program interface (API), the method being performed by an application, including: generating an ID plug interface, and binding an ID of the application to the generated ID plug interface; requesting a domain controller to do a domain search through the ID plug interface; receiving a domain socket interface list from the domain controller through the ID plug interface; selecting one domain socket interface in the domain socket interface list; and requesting plug-to of the ID plug interface into the selected domain socket interface, wherein, when the ID plug interface is plugged into the selected domain socket interface in response to the requesting of the plug-in, the application belongs to a domain related to the domain socket interface, and an ID-based communication setting of the application is completed.

In an embodiment, the requesting of the domain controller to do the domain search, may include: requesting, by the application, the ID plug interface to do the domain search having desired delivery characteristics; and transmitting, by the ID plug interface, the requesting of the domain search to the domain controller.

In an embodiment, in the ease of absence of the domain socket interface corresponding to the desired delivery characteristics, the domain controller may generate the socket interface corresponding to the desired delivery characteristics.

In an embodiment, when the ID plug interface is plugged into the selected domain socket interface, the domain socket interface may update a locator with respect to an ID of the application.

In an embodiment, the application may perform communication with a remote communication entity through the plugged ID plug interface and domain socket interface.

In an embodiment, the application may transmit a payload and an ID of the remote communication entity to which the application wants to transmit to the ID plug interface, the ID plug interface may convert the payload into a packet including the ID of the remote communication entity in the header and transmit the packet to the domain socket interface, and the domain socket interface may transmit the packet to the remote communication entity.

In an embodiment, the application may register a callback function in the ID plug interface for receiving data from the remote communication entity.

In an embodiment, when the packet is received from the remote communication entity through the domain socket interface, the ID plug interface may store the payload included in the packer in a specific buffer, and transmit the stored payload to the application using the callback function.

In an embodiment, the ID-based communication method may further include: requesting, by the application, a communication termination through the ID plug interface, wherein, when the communication termination is requested, the plug-in of the ID plug interface into the domain socket interface may be released, and the ID plug interface may be removed.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic diagram illustrating an identifier (ID)-based communication architecture to which an application program interface (API) is applied according to an embodiment of the present invention;

FIG. 2 is a flowchart for describing an ID-based communication process using an API according to an embodiment of the present invention;

FIG. 3 is a diagram for describing a communication method using an ID plug interface (iPlug) and a domain socket interface (dSocket) according to an embodiment of the present invention; and

FIG. 4 is a block diagram illustrating a construction of a communication node in which an application may be executed.

### DETAILED DESCRIPTION OF EXEMPLARY EMBODIMENTS

Exemplary embodiments of the present invention will be described in detail below with reference to the accompanying drawings. However, the present invention is not limited to specific exemplary embodiments, and it will be understood to those skilled in the art that various modifications and equivalent and alternative forms can be made without departing from the spirit and scope of the invention.

Hereinafter, in the following description with respect to embodiments of the present invention, when a detailed description of known functions or configurations related to the present invention unnecessarily obscures the gist of the present invention, a detailed description thereof will be omitted.

Further, it will be understood that a singular expression used in this specification and claims generally means “at least one” if not specifically denoted.

Moreover, “module”, “unit”, ‘interface”, etc. among terms used in this specification generally mean computer related objects, for example, hardware, software, and a combination thereof.

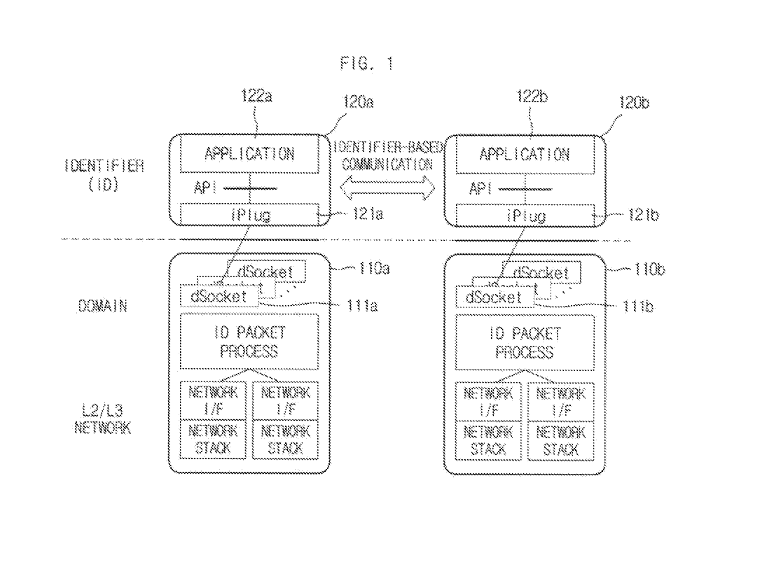

FIG. 1 is a schematic diagram illustrating an identifier (ID)-based communication architecture to which an application program interface (API) is applied according to an embodiment of the present invention.

As shown, assume that a communication entity 120a and a communication entity 120b perform an ID-based communication through a different domain. IDs given to the communication entities 120a and 120b may not include address-related information different from a conventional IP. It may be information for identifying the communication entities 120a and 120b, and may be defined as a bit string in which global uniqueness is guaranteed. The domain may define a logical or physical unit of a communication environment having a specific network mechanism. There are gateways 110a and 110b in the domain. In conventional IP-based communication, every communication entity is a host since the IP is assigned to a network interface of a host. However, in the ID-based communication, IDs may be given to an entity, which is a communication target such as a service, content as well as the host, and the communication may be performed based on the given IDs. In order to perform the communication between the communication entities, the gateways 110a and 110b may include an ID packet process function of finding a location of a counterpart entity using the ID of the counterpart entity, setting a path toward the counterpart entity, and transmitting a packet through the set path.

In order to find location of the communication entity using its ID, first, the communication entity may register its existence to a communication environment defined as the domain, and add/change a locator in a hierarchical domain structure. The registration of the communication entity and management of the location information may be performed by an ID-locator mapping system.

The gateways 110a and 110b may obtain a locator corresponding to a counterpart ID from the mapping system, set a path based on the corresponding locator, and determine forwarding with respect to a next hop when the path is set. The host may transmit an ID packet to the next hop according to a network mechanism (IPv4, IPv6, or Ethernet) of a domain to which it currently belongs to. The ID packets may be finally transmitted to the host in which there is a counterpart communication entity through the domains having a different network mechanism. A return path may be set as the same method, or a reverse forwarding path may be simultaneously set when setting the forwarding path.

According to an embodiment of the present invention, an interface provided to the communication entity for the ID-based communication and an interface provided to the domain may be separately defined.

The ID plug interfaces (‘ID plug’ or ‘iPlug’) 121a and 121b provided to the communication entities may perform a function of managing communication entity information and an end-to-end communication. The iPlugs 121a and 121b may be generated by applications 122a and 122b, respectively. An ID of the application 122a may be designated to the iPlug 121a, and an ID of the counterpart application 122b may be stored in the iPlug 121a. Further, a buffer for the end-to-end communication may be defined, and an end-to-end flow control using the buffer may be defined.

Meanwhile, domain socket interfaces (‘dSockets’) 111a and 111b provided to the domain may perform a function of managing domain information and communication between domains. The dSockets 111a and 111b may be generated and managed by a domain controller. The location information of the domain, a domain intrinsic protocol/interface, network status information, location search of a counterpart ID, a path setup, packet transmission and reception, etc. may be defined in dSockets 111a and 111b.

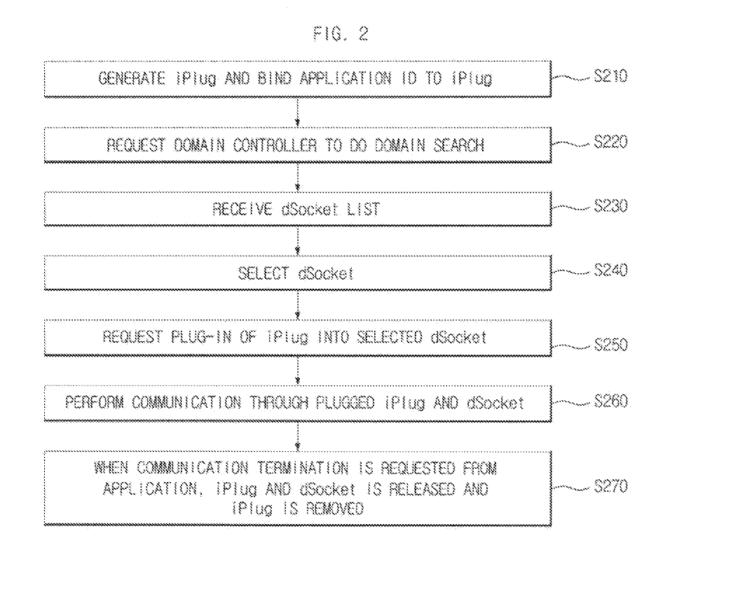

FIG. 2 is a flowchart for explaining an ID-based communication process using an API according to an embodiment of the present invention.

Assume that an application which wants to communicate have known an ID of a remote communication target entity. An operation of acquiring a counterpart ID may be performed according to various methods such as mapping database search, etc., but the present invention is not limited thereto.

Here, the application may be an execution subject for a service ID or content ID. When the application is for providing a service regarding a business logic or information, etc., the application may be the communication entity represented by the service ID. Meanwhile, when the application is for providing access to the content having the ID, the application may be a processing agent for the content, which has no processing ability. In other words, the application may represent a service or contents, depending on its own role and/or ID assignment mechanism.

With reference to FIG. 2, the application which wants to perform the ID-based communication may generate the iPlug and bind an ID of the application to the generated iPlug (S210).

In an embodiment, the application may generate the iPlug using a createIPlug( ). Here, the application can designate an operational attribute of a network layer, which is requested by the application as intent.

After generating the iPlug, the application may request the domain controller to do a domain search through the iPlug (S220). Specifically, the application may request the iPlug to do the domain search having desired delivery characteristics. The iPlug may then forward the domain search request to the domain controller. At this time, the application may designate the desired domain delivery characteristics (for example, trusted delivery/untrusted delivery) through the iPlug.

The domain controller may perform a mediator role for a connection between the communication entity and the domain. The domain controller may be implemented in various manners in the ID-Based communication architecture. In an embodiment, the domain controller may manage a list of domains existing within its own area and a list of the dSockets representing inlet points of the domains. The domain controller may have a right of generating the dSocket of a specific domain, if necessary.

In an embodiment, the domain controller may search a domain having delivery characteristics requested by the application, and provide a list of the dSockets needed for connecting with the domain to the iPlug.

In an embodiment, when the dSocket with domain characteristics requested by the application does not exist, the domain controller may generate a dSocket corresponding to the requested domain characteristic and provide it to the iPlug. The application may receive the list of the dSockets related to the domain which is accessible by the domain controller through the iPlug (S230).

The application may select one from the dSocket list (S240), and request plug-in of the iPlug into the selected dSocket (S250). In response to the request of the plug-in, the iPlug is plugged into the selected dSocket. The application may then belong to a domain related to the dSocket. Accordingly the ID-based communication for the application may be set.

In an embodiment when the iPlug is plugged into the selected dSocket, the dSocket may update a locator with respect to the ID of the application.

When the setting of the ID-based communication is completed, the application may perform a packet transmission and reception with the remote communication entity through the combined iPlug and the dSocket (S260).

In an embodiment, the application forwards a desired payload to be transmitted to a remote communication entity and an ID of the remote communication entity to the iPlug. The iPlug then converts the payload into a packet in which the ID of the remote communication entity is included in a header and transmits the packet to the dSocket. The dSocket then forwards the packet to the remote communication entity.

Meanwhile, the application may previously register a callback function in the ID plug interface iPlug in order to receive data from the remote communication entity. When the packet is received from the remote communication entity through the dSocket the iPlug may store the payload included in the packet in a designated buffer, and transmit the payload to the application using the registered callback function.

Finally, the application may request a communication termination through the iPlug. When the communication termination is requested, the plug-in of the iPlug into the dSocket may be released, and the iPlug may be removed.

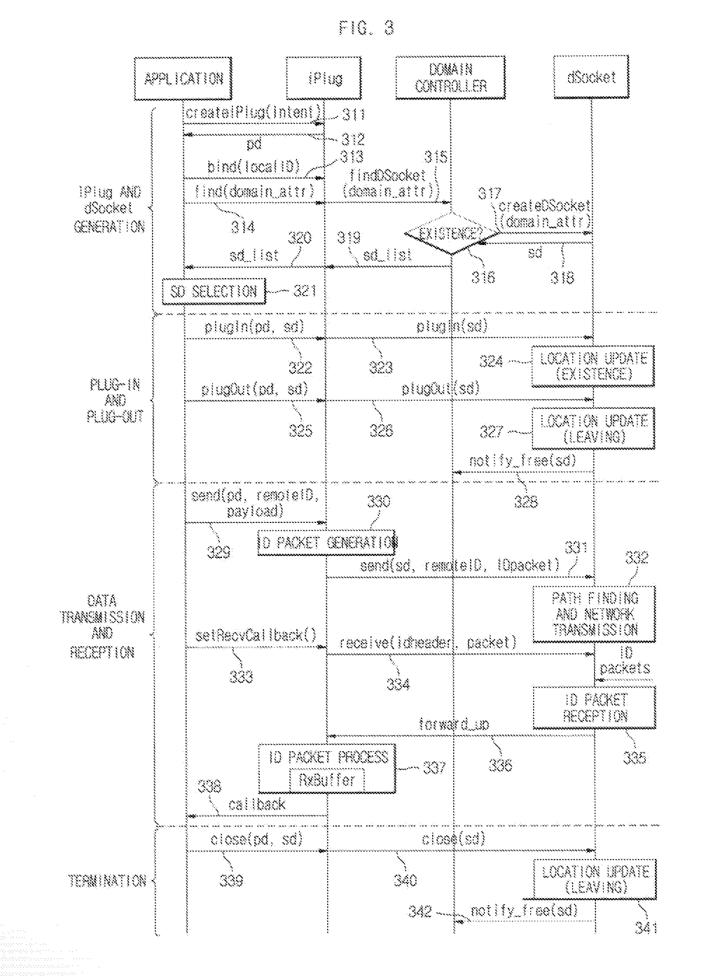

FIG. 3 is a diagram illustrating a communication method using an iPlug and a dSocket. As shown, a mutual operation may be largely classified as an iPlug and dSocket generation, plug-in and plug-out, a data transmission and reception, and a communication termination. Hereinafter, each operation will be described.

iPlug and dSocket Generation

1. The application may generate the iPlug using a createIPlug( ) (311), and acquire a plug descriptor pd with respect to the generated iPlug (312). Next, the application may bind its own ID to iPlug (313). APIs used in the operation are as follows.

iPlug API—createIPlug( )
It is used when the application generates the iPlug,
Intent may represent an operational attribute of a network layer requested by the application. The intent may be represented as a value such as ‘datagram’, ‘stream’ and so on, which may be expansively defined.
As a result value of creatIPlug( ) function, the plug descriptor pd used to access the generated iPlug may be returned.

An input/output parameter of the createIPlug( ) may be described in the following Table 1.

TABLE 1

| Parameter name | | Type | Option | Description |
|---|---|---|---|---|
| Input | Intent | integer | No | Type of Intent |
| | | | | default value: 0 |
| | | | | datagram: 1 |
| | | | | stream: 2 |
| | | | | others: expansively |
| | | | | defined |
| Output | Result | integer | No | Success: |
| | (plug_descrip- | | | plug_descriptor > 0 |
| | tor) | | | Failure: −1 |

iPlug API—bind( )
It may be used when the application may bind its own ID to the iPlug.

The following table 2 may describe the input/out parameter of a bind( ).

TABLE 2

| Parameter name | | Type | Option | Description |
|---|---|---|---|---|
| Input | plug_descriptor | integer | No | |
| | localID | ID | No | Communication entity ID |
| Output | Result | integer | No | Failure: −1 |

2. The application may request the iPlug to perform a find( ) function in order to find a domain of a desired attribute (314), and the iPlug may transmit a corresponding request to the domain controller (315). The domain controller may search whether there is the requested dSocket (316), generate the dSocket when there is no dSocket, and return the dSocket list sd_list to the iPlug. The iPlug may transmit the sd_list to the application (320). APIs used in this process are as follows.

iPlug API—find( ):
It is used tor finding a proper communication environment which the application wants.
A domain attribute domain_attr may be set as a parameter with respect to delivery characteristics provided in the domain, designate a value such as trusted, or animated, and be expansively defined.
An accessible dSocket list sd_list of may be returned.

Hereinafter, Table 3 may describe the input/output parameter of the find( ).

TABLE 3

| Parameter name | | Type | Option | Description |
|---|---|---|---|---|
| Input | domain_attr | integer | Yes | domain delivery |
| | | | | characteristics |
| | | | | 0: defalult(any domain) |
| | | | | 1: trusted delivery |
| | | | | 2: untrusted delivery |
| Output | result (sd_list) | integer | No | Domain socket list |
| | | array | | ‘Null’ means that |
| | | | | there is no proper dSocket |

dSocket API—findDsocket( )
It is used when the iPlug requests the domain controller to search for a proper dSocket
A value of the input/output parameter may be equal to the find( ) of an iPlug API.

TABLE 4

| Parameter name | | Type | Option | Description |
|---|---|---|---|---|
| Input | domain_attr | integer | Yes | Domain delivery |
| | | | | characteristics |
| | | | | 0: default(any domain) |
| | | | | 1: trusted delivery |
| | | | | 2: untrusted delivery |
| Output | result | integer | No | Domain socket list |
| | (sd_list) | array | | ‘Null’ means that |
| | | | | there is no proper dSocket |

dSocket API—createDSocket( )
It is used when the domain manager generates the dSocket.
The domain_attr may be used for selecting a desired network delivery characteristic such as the trusted/untrusted delivery. This may be expansively defined.
The generated dSocket descriptor may be returned as a result value.

A value of the input/output parameter of the createDSocket( ) will be described the following Table 5.

TABLE 5

| Parameter name | | Type | Option | Description |
|---|---|---|---|---|
| Input | domain_attr | integer | Yes | Domain delivery |
| | | | | characteristics |
| | | | | 0: default |
| | | | | 1: trusted delivery |
| | | | | 2: untrusted delivery |
| Output | Result | integer | No | Success: |
| | (dSocket_descrip- | | | dSocket_descrip- |
| | tor) | | | tor > 0 |
| | | | | Failure: −1 |

3. The application may select a proper sd in the sd_list (321), and complete a connection setup between the communication entity and the communication environment (domain).

### Plug-In & Plug-Out

4. The application may perform a plugIn( ) to join to a specific domain (322, 323). Accordingly, the locator of the application may be determined, and a locator update (presence) may be performed (324). APIs used in this operation are as follows.

iPlug API—plugIn( )
It is used when the application requests plug-in of its own iPlug into the dSocket. The API becomes to belong to a specific communication environment, that is, a domain, through an execution of plugIn( ).

TABLE 6

| Parameter name | | Type | Option | Description |
|---|---|---|---|---|
| Input | plug_descriptor | integer | No | |
| | dSocket_descriptor | integer | No | |
| Output | Result | integer | No | Failure: −1 |

dSocket API—plugIn( )
It is used when the iPlug requests to plug-in to the dSocket. The dSocket may update a locator with respect to the ID based on information of the connected iPlug

TABLE 7

| Parameter name | | Type | Option | Description |
|---|---|---|---|---|
| Input | dSocket_descriptor | integer | No | |
| Output | Result | integer | No | Failure: −1 |

5. The application may perform a plugOut( ) when leaving from a specific domain (325 and 326). Accordingly, since its own locator is released, a locator update (leaving) may be subsequently performed (327). APIs used in this operation are as follows.

iPlug API—plugOut( )
It is called by the application when the application releases a connection setting with the dSocket.
It means the separation from the domain to which the application belongs, but not a communication termination.

TABLE 8

| Parameter name | | Type | Option | Description |
|---|---|---|---|---|
| Input | plug_descriptor | integer | No | |
| | dSocket_descriptor | integer | No | |
| Output | Result | integer | No | Failure: −1 |

dSocket API—plugOut( )
It is called by the iPlug to releases a connection setting with the dSocket to which the iPlug is connected. It means re-separation between the communication entities, and may not mean the communication termination of the application.
Next, the dSocket may inform the domain controller of the connection release with the iPlug.

TABLE 9

| Parameter name | | Type | Option | Description |
|---|---|---|---|---|
| Input | dSocket_descriptor | integer | No | |
| Output | Result | integer | No | Failure: −1 |

### Data Transmission and Reception

6. When the application calls the send( ) using the remote communication entity ID and data (329), the iPlug may generate an ID packet (330), and transmit the packet to the dSocket to which the iPlug is bound (331). The dSocket may transmit an ID packet to the counterpart communication entity through an ID lookup, a path set and forwarding operations (332) in the domain. APIs used in this operation are as follows.

iPlug API—send( )
It is used when the application transmits the ID packet through the iPlug.
The application may transmit the counterpart ID address and payload.

TABLE 10

| Parameter name | | Type | Option | Description |
|---|---|---|---|---|
| Input | plug_descriptor | integer | No | |
| | remoteID | ID | No | Counterpart |
| | | | | communication |
| | | | | entity ID |
| | Payload | pointer of | No | Payload pointer to |
| | | buffer | | be transmitted |
| | sending_size | integer | No | A size of payload to |
| | | | | be transmitted |
| Output | result | integer | No | Success: transmitted |
| | (sent_size) | | | packet byte size |
| | | | | Failure: −1 |

dSocket API—send( )
When the iPlug receives a data transmission request from the application, the iPlug may generate the ID packet by adding transmission and reception IDs in its header and transmit the ID packet to the dSocket using a send( ).

TABLE 11

| Parameter name | | Type | Option | Description |
|---|---|---|---|---|
| Input | dSocket_descriptor | integer | No | |
| | remoteID | ID | No | Counterpart |
| | | | | communication |
| | | | | entity ID |
| | id_packet | ID_packet | No | ID packet to |
| | | | | be transmitted |
| | sending_size | integer | No | Size of ID |
| | | | | packet to be |
| | | | | transmitted |
| Output | result | integer | No | Success: trans- |
| | (sent_size) | | | mitted packet |
| | | | | byte size |
| | | | | Failure: −1 |

7. When the ID packet is received (335), the dSocket may transmit a packet to the iPlug to which the dSocket is bound (336), the iPlug may perform a flow control through a packet buffer, and transmit the packet to the application using a callback function which has been registered (337).

iPlug API—setRecvCallback( )
The application may register a function for processing the received ID packet.

TABLE 12

| Parameter name | | Type | Option | Description |
|---|---|---|---|---|
| Input | callback_fn_name | function | No | Pointer to function |
| | | pointer | | of processing the |
| | | | | received data |
| Output | result | integer | No | Failure: −1 |

iPlug API—forward_up( )
If the dSocket receives a packet, it calls a forward_up( ) for forwarding the packet.

TABLE 13

| Parameter name | | Type | Option | Description |
|---|---|---|---|---|
| Input | id_packet_buffer | pointer of | No | Pointer to Rx |
| | | butter | | buffer that is |
| | | | | used for storing |
| | | | | the received data |
| | receiving_size | integer | No | Payload size |
| | | | | to be received |
| Output | result | integer | No | Success: the |
| | (received_size) | | | number of bytes of |
| | | | | received packet |
| | | | | Failure: −1 |

dSocketAPI—Receive( )
The iPlug may be used for requesting an ID packet reception from the counterpart communication entity to the dSocket.
A buffer pointer to receive the packet may be transmitted as a parameter.

TABLE 14

| Parameter name | | Type | Option | Description |
|---|---|---|---|---|
| Input | id_packet_buffer | ID_Packet | No | Buffer pointer |
| | | | | in which the |
| | | | | received data |
| | | | | is stored |
| | receiving_buffer_size | integer | No | ID packet size |
| | | | | to be received |
| Output | Result | integer | No | Failure: −1 |

### Communication Termination

8. The application may perform an explicit termination using a close( ) (339, 340). Accordingly, first a connection with the dSocket may be released, the locator may be updated (341), and the iPlug may be removed.

iPlug API—close( )
The application may call the close( ) for the communication termination.

TABLE 15

| Parameter name | | Type | Option | Description |
|---|---|---|---|---|
| Input | plug_descriptor | integer | No | |
| | dSocket_descriptor | integer | No | |
| Output | result | integer | No | Failure: −1. |

dSocket API—close( )
The iPlug may call the close( ) for the communication termination with the dSocket
As a result, the dSocket may release a related communication resource, and return to an idle state.

TABLE 16

| Parameter name | | Type | Option | Description |
|---|---|---|---|---|
| Input | dSocket_descriptor | integer | No | |
| Output | result | integer | No | Failure: −1. |

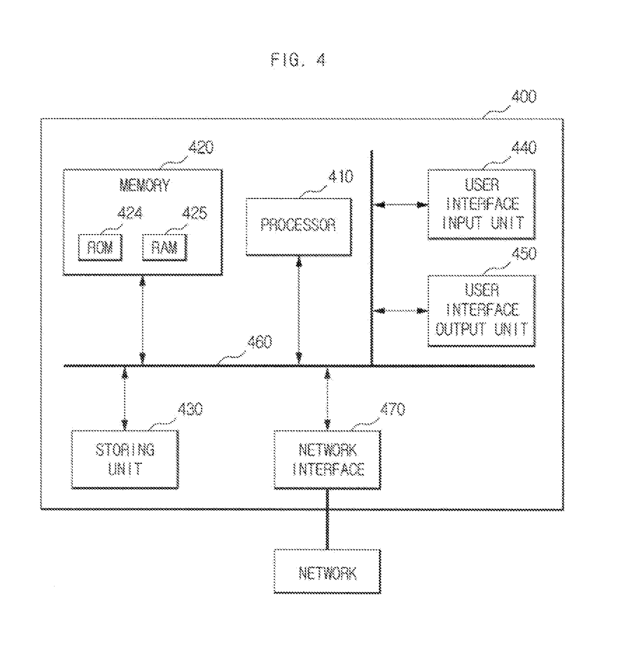

FIG. 4 is a block diagram illustrating a construction of a communication node in which an application may be executed. As shown in FIG. 4, a communication node 400 may include one or more of a processor 410, a memory 420, a storage unit 430, a user interface input unit 440, and a user interface output unit 450, which may communicate with each other through a bus 460. Further, the communication node 400 may include a network interface 470 for connecting to a network. The processor 410 may be a central processing unit (CPU) or a semiconductor device for executing a command stored in the memory 420 and/or the storing unit 430. The memory 420 and the storing unit 430 may include various types of volatile/non-volatile storage media. For example, the memory 420 may include a read only memory (ROM) 424 and a random access memory (RAM) 425.

The ID-based communication operation and various application programming interfaces (APIs) provided for the operation according to an embodiment of the present invention described above may be implemented by program instructions, and may be stored in the memory 420 and executed by the processor 410.

The embodiments of the present invention described above may be recorded in a computer readable recording medium by being implemented as a program command type executable through various computer units. The computer readable recording medium may include a program command, a data file, a data structure, etc. or in combination.

The program command recorded in the computer readable recording medium may be specifically designed and configured for the present invention, or may be a command which is well known and used by those of ordinary skill in the computer software field. Examples of the storage medium may be a hardware device which is specially configured to store and execute the program command including a magnetic medium such as a hard disk, a floppy disk, and a magnetic tape, an optical recording medium such as a compact disc-read only memory (CD-ROM) and a digital video disc (DVD), a magneto-optical medium such as a read only memory (ROM), a random access memory (RAM), or a flash memory. In addition, the storage medium may be a transmission medium such as optical or metallic lines, waveguides including a carrier waver transmitting signals specifying the program command, the data structure, etc. Examples of the program command may include a device which electronically processes information using an interpreter, etc, for example, high-level language codes which are executable by a computer, as well as machine codes which are made by a compiler.

The apparatus described above may be configured to be operated by one or more software modules it order to perform an operation of the present invention, and vice versa.

The present invention can easily support mobility of the communication entity and multi-homing by separately providing the communication entity interface and the communication environment interface for an ID-base communication architecture in which the communication entity and the communication environment are separated.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An Identifier (ID)-based communication method using an application program interface (API), the method being performed by an application, comprising:
generating an ID plug interface and binding an ID of the application to the generated ID plug interface;
requesting a domain controller to do a domain search through the ID plug interface;
receiving a domain socket interface list from the domain controller through the ID plug interface;
selecting one domain socket interface in the domain socket interface list; and
requesting plug-in of the ID plug interface into the selected domain socket interface,
wherein, when the ID plug interface is plugged into the selected domain socket interface in response to the requesting of the plug-in, the application belongs to a domain related to the domain socket interface, and an ID-based communication setting of the application is completed.

2. The ID-based communication method of claim 1, wherein the requesting of the domain controller to do the domain search, comprises:
requesting, by the application, the ID plug interface to do the domain search having desired delivery characteristics; and
forwarding, by the ID ping interface, the requesting of the domain search to the domain controller.

3. The ID-based communication method of claim 2, wherein, in the case of absence of the domain socket interface corresponding to the desired delivery characteristics, the domain controller generates the socket interface corresponding to the desired delivery characteristics.

4. The ID-based communication method of claim 1, wherein, when the ID plug interface is plugged into the selected domain socket interface, the domain socket interface updates a locator with respect to an ID of the application.

5. The ID-based communication method of claim 1, wherein the application performs communication with a remote communication entity through the plugged ID plug interface and domain socket interface.

6. The ID-based communication method of claim 5, wherein the application transmits a payload and an ID of the remote communication entity to which the application wants to transmit to the ID plug interface, the ID plug interface converts the payload into a packet including the ID of the remote communication entity in the header and transmits the packet to the domain socket interface, and the domain socket interface transmits the packet to the remote communication entity.

7. The ID-based communication method of claim 5, wherein the application registers a callback function in the ID plug interface for receiving data from the remote communication entity.

8. The ID-based communication method of claim 7, wherein, when the packet is received from the remote communication entity through the domain socket interface, the ID plug interface stores the payload included in the packet in a specific buffer, and transmits the stored payload to the application using the callback function.

9. The ID-based communication method of claim 1, further comprising:
requesting, by the application, a communication termination through the ID plug interface,
wherein, when the communication termination is requested, the plug-in of the ID plug interface to the domain socket interface is released, and the ID plug interface is removed.
